(19) United States
(12) Patent Application Publication
(10) Pub. No.: US 2021/0097526 A1
(43) Pub. Date: Apr. 1, 2021

(54) TRANSACTION SYSTEM AND METHOD

(71) Applicants: Sean Anthony EDMISTON, NSW (AU); David Kenneth EHRLICH, NSW (AU); MOBILE TECHNOLOGY HOLDINGS LIMITED, Douglas (IM)

(72) Inventors: Sean Anthony Edmiston, Tintenbar, NSW (AU); David Kenneth Ehrlich, Dolls Point, NSW (AU)

(21) Appl. No.: 17/050,174

(22) PCT Filed: Apr. 17, 2019
(86) PCT No.: PCT/AU2019/050344

§ 371 Date: Oct. 23, 2020

Related U.S. Application Data
(60) Provisional application No. 62/661,081, filed on Apr. 23, 2018.

(51) Int. Cl. G06Q 20/32; G06Q 20/38; G06Q 40/02; G06Q 30/02; G06Q 20/20; G06K 7/10; G06K 7/14; G06K 19/06; H04L 9/32

(52) U.S. Cl. CPC G06Q 20/3274; G06Q 20/385; G06Q 40/02; G06Q 30/0226; G06Q 20/3827; G06Q 20/208; G06Q 20/3672; G06K 7/143; G06K 19/06112; H04L 9/3236; G06Q 2220/00; G06Q 20/3255; G06K 7/1095

(57) ABSTRACT

A system and method for facilitating transactions using a tokenization process. A user's primary account number (PAN) may be provided by first generating an optically scannable code that can be delivered in a message to a user device, such as via SMS. The code is scanned by a reader associated with a merchant terminal and processed, e.g. via a one-way cryptographic hash, into a processing token such as a Bank Identification Number (BIN) range token. The processing token can be stored in a token vault in association with the PAN. During a transaction, the user scans their code at a reader associated with a merchant terminal. The merchant terminal manipulates the code into a processing token which is then passed into a transaction network for conversion into the PAN and subsequent transaction processing. The system is able to provide both financial transactions and loyalty program accounting using the tokenization methods.

### TECHNICAL FIELD OF THE INVENTION

This disclosure relates primarily, though not exclusively, to systems and methods for providing authentication and verification of persons and similar entities. The disclosure has particular, though not exclusive, relevance to facilitating authentications and associated processing in a range of transactions.

### BACKGROUND OF THE INVENTION

Any reference herein to known prior art does not, unless the contrary indication appears, constitute an admission that such prior art is commonly known by those skilled in the art to which the invention relates, at the priority date of this application.

Tokenization has become a popular method for enabling mobile devices to be used directly in a transaction. In a typical tokenization method, a user downloads a payment application (app), e.g. Apple Pay, issuing bank app, etc. to their mobile device and then enters their credit card details into the payment app. The payment app then contacts the issuing bank which issues a token to the payment app. The token is a substitute or surrogate for the Primary Account Number (PAN) of the user's credit card. Typically, the token is a number having the same form as the credit card number, e.g. 16 digits. Thus, the token appears as a valid PAN but cannot be used directly in a transaction. The payment app and/or issuing bank stores the PAN and associated token in a secure data store termed a token vault. The token will typically be in a Bank Identification Number (BIN) range of the token vault which may be different to the BIN range for the issuing bank. The token is pushed to the user's device and the user device thus stores only the token, not the original PAN or other credit card information.

When a transaction is to be conducted, the user invokes the payment app and provides their token to a merchant reader, e.g. using near-field communications protocols. The token and the transaction details are then passed by the merchant systems into a transaction processing system during which a call is made to the token vault to retrieve the PAN associated with the token. The issuing bank is then able to authorize the transaction.

Tokenization offers many security benefits. In addition to the mobile device not storing credit card details, the merchant need only store tokens, rather than credit card details, and tokens themselves can be made merchant specific. Thus, if a merchant's system is hacked or otherwise compromised, only the tokens for that merchant need to be replaced. The issuing bank does not need to cancel and reissue the PAN.

While tokenization offers many security benefits, a problem remains that the issuing bank still needs to provide the user a card detailing the Primary Account Number. This can be problematic if the security of the card becomes compromised. Furthermore, the token can only be used in mobile devices that have installed appropriate payment apps and can communicate tokens via near-field communications protocols. This can limit the range of transactions in which the mobile transaction system is deployed.

Many of the token service providers charge additional fees which introduces another entity into the transaction process. This either adds to the costs to the consumer or reduces the profits of the existing entities, e.g. either the merchant or the banks.

This therefore identifies a need for an improved system and method for conducting financial transactions and/or an improved system and method for issuing user's with financial account information.

### SUMMARY OF THE INVENTION

For transaction processing, tokenization of a user's primary account number (PAN) may be provided by first generating an optically scannable code that can be delivered in a message to a user, such as via SMS. The optically scannable code can be processed, e.g. via a one-way cryptographic hash, into a processing token such as a BIN range token. The processing token can be stored in a token vault in association with the PAN. During a transaction, the user scans their code at a merchant terminal. The merchant terminal manipulates the code into a processing token which is then passed into a transaction network for conversion into the PAN and subsequent transaction processing. The system is able to provide both financial transactions as well as loyalty program accounting using the tokenization methods.

In one aspect of the invention, there is provided a method of provisioning a system for using processing tokens for transactions. In the method, a delivery code may be generated which may be processed into a processing token via a one-way algorithm. The processing token may be associated with an account identifier of a user and the association stored in a token vault. An optically scannable message including the delivery code may be generated and delivered to a device of a user for subsequent use during merchant transactions. The user device may be a mobile telephone device, a smart device, a smart watch or any other user device including a mobile device of the user.

In one aspect of the invention, there is provided a method of conducting a financial transaction using a user device and a merchant terminal. The method may include obtaining, at a scanner of the merchant terminal, an optically scannable code from the user device. The optically scannable code may be converted into a Bank Identification Number (BIN) range processing token at the scanner. The merchant terminal may provide the BIN range processing token from the merchant terminal into a financial network for authorizing payment for the transaction to the merchant from a Primary Account Number (PAN) associated with the BIN range processing token. The user device may be a mobile telephone device, a smart device, a smart watch or any other user device including a mobile device of a user.

In one aspect of the invention, there is provided a system for providing transactions using tokenization processes. The system may include at least one token vault, at least one Issuer that stores a primary account number for at least one user, and at least one token provisioning module. The token provisioning module may be configured to generate at least one delivery code and generate at least one processing token from the delivery code via a one-way algorithm. The token vault may be configured to store an association between a delivery code/processing token pair and a primary account number.

The above description sets forth, rather broadly, a summary of some embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Reference will now be made, by way of example only, to specific embodiments and to the accompanying drawings in which:

FIG. 1 shows an embodiment of an optically scannable code;

FIG. 2 shows a mobile phone device displaying an optically scannable code;

FIG. 3 shows a process for creating an optically scannable code from a BIN range processing token;

FIG. 4 shows a system and process for provisioning bCODE/processing token pairs;

FIG. 5 shows a system and process for conducting a financial transaction using an optically scannable code;

FIG. 6 shows an embodiment of a scanner;

FIG. 7 shows a method for provision bCODE/processing token pairs and delivery bCODEs to users;

FIG. 8 shows a method for conducting a financial transaction using an optically scannable code;

FIG. 9 shows a system and process for provisioning bCODEs as gift cards;

FIG. 10 shows a method for provisioning bCODEs as gift cards;

FIG. 11 shows a system and process for using bCODEs for a loyalty/coupon program with a CRM integrated into an ECR;

FIG. 12 shows a method for uses bCODEs for a loyalty/coupon program with a CRM integrated into an ECR;

FIG. 13 shows a system and process for using bCODEs for a loyalty/coupon program without a CRM integrated into an ECR;

FIG. 14 shows a method for uses bCODEs for a loyalty/coupon program via a POS terminal;

FIG. 15 shows a system using an aggregation service for multiple loyalty programs;

FIG. 16 shows a method using an aggregation service; and

FIG. 17 shows a system for using bCODEs representing BIN range processing tokens in an online shopping embodiment.

### DETAILED DESCRIPTION OF PREFERRED EMBODIMENTS

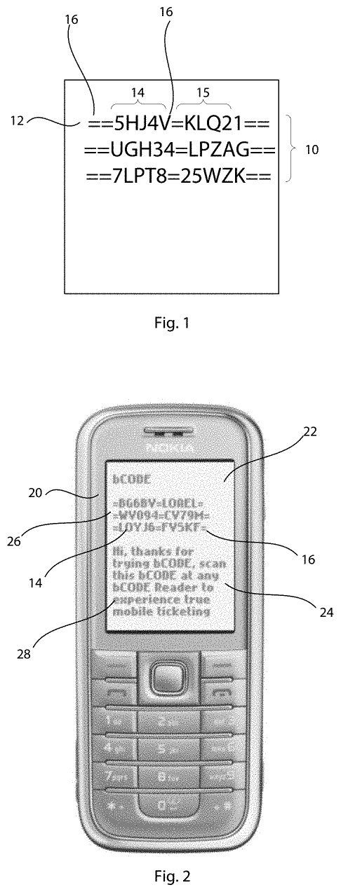

In W02005/083640 and W02006/060849, the entire contents of each of which are incorporated herein by reference, the Applicant has described a system and method by which coded information may be distributed to users in an optically scannable code via text messaging. The Applicant has further described how such optically scannable codes, termed in the Applicant's proprietary language as bCODEs, can be scanned and processed by relatively simple optical scanners. FIG. 1 shows a method of encoding information or “initial data” into a portable alphanumeric string geometry (“N-Code”). Such an alphanumeric string is easily transmitted wirelessly to all messaging supporting mobile devices whereupon it may be optically scanned and reliably decoded back to the original encoded information for various purposes.

In one example of FIG. 1, sixteen to eighteen digits of information are transmitted as a message that results in 3 lines of text 10. Each line, e.g. line 12, has two sets 14, 15 of five alphanumeric characters that represent the coded information. Each line 12 is bounded at each edge by at least one special marker character 16. In the specific example, two special marker characters 16 are provided at the start and end of each line. The sets 14, 15 are also separated by the same special marker character 16. The present example, the special marker character is the symbol “=”. The “=” is considered distinctive because it is least likely to be confused at a visual level with any other character. Alternatively, other similar methods can be used to utilize the geometric uniqueness of certain alphanumeric characters to define recognized forms of N-Codes for efficient optical processing. These include alternating patterns such as alternating between uppercase to lowercase to uppercase on character progression along a line (e.g. aBcDmPdYoG), known patterns such as using pre-defined multi-character sequences (e.g. b57-z82-p45-), and location-sensitive character mapping where the characters used for mapping is a function of each character's own x and y coordinates in rows and columns. As an example to the location-sensitive character mapping, one mapping rule could be that third row characters should only contain uppercase letters between M and Z (e.g. Line1=29183902, Line2=addcedpqz, Line3=MNPZZQRM). These similar methods are all designed to create geometric patterns in the raw captured image of the N-Code that the decoding system can use as hints to locate the code and decode the image. This method of applying alphanumeric geometry creates a system of encoding and decoding alphanumeric data with satisfactory scan reliability and speed for commercial deployment.

While the specific example of FIG. 1 shows three lines 12 of information, any number of lines may be provided. Each line 12 is shown as having two sets 14, 15, though any number of sets may be provided. Each set 14,15 is shown as containing five characters, though more or less characters may be provided in each set. Blank lines or lines marker lines containing predetermined symbols or patterns of symbols (e.g. ========) may be added to aid in the scanning and character recognition processes if required.

As shown in FIG. 2, a user mobile phone device 20 is shown in a messaging mode in which a display 22 of the device 20 displays a message 24 within which is a bCODE 26. The bCODE portion of the message 26 shows the transmitted special characters 16 in the encoding character set that are easily recognizable to act as markers in the rectangular display geometry so that the image capture and processing algorithms can more efficiently recognize and decode the image. In this example, a single alphanumeric character “=” is used as a boundary symbol. Sets of five information characters 14 such as alphanumeric characters are located between separated boundary characters 16. The displayed message may include non-coding descriptive text 28 located outside of the target area defined by the four corner located special characters 16. The particular form of the bCODE and the descriptive text 28 is for illustrative purposes only and is not intended to convey specific information about the present invention.

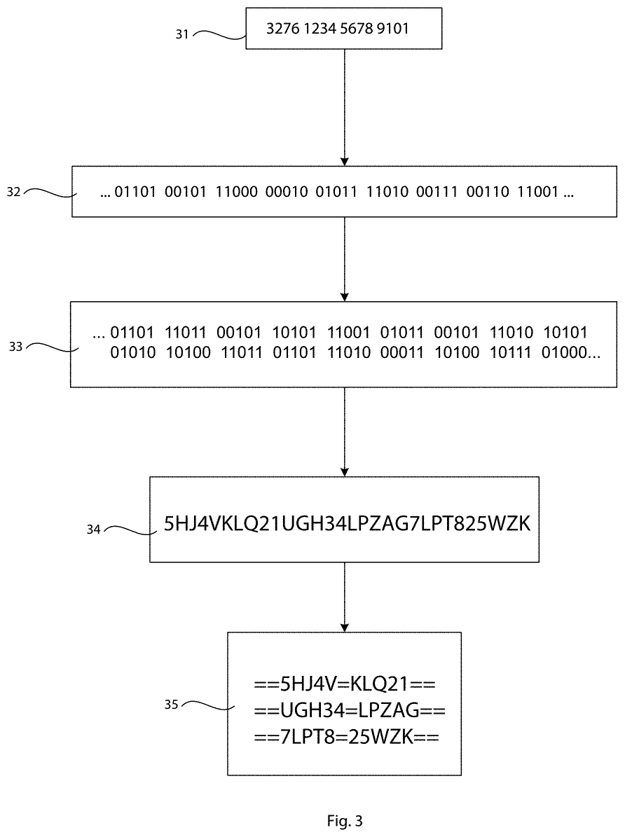

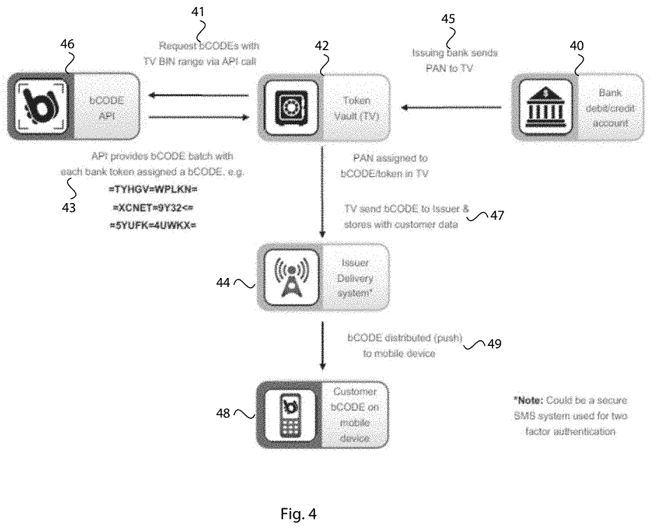

FIG. 3 shows a method by which initial data can be formatted into a bCODE format. The initial data may be, for example, a BIN range token 31 that is first converted to an encrypted sequence of binary digits 32. The binary sequence 32 may include additional data, e.g. a header information, check sum, etc.

A bit based data redundancy algorithm, e.g. Reed Solomon and/or encryption algorithm, may be applied to the bit sequence 32 to form an encoded sequence 33. The encoded sequence 33 is depicted in FIG. 3 in five-bit blocks. Each five bit block may be mapped to an alphanumeric character via a character mapping to produce the bCODE sequence 34. The character mapping may not include all available alphanumeric characters. In various embodiments, the character mapping may omit certain alphanumeric characters that can be difficult to accurately resolve in an optical character recognition process. For example, the characters “0”, “D” and numeral “0” can be readily confused and thus may be omitted from the character map.

Once the alphanumeric sequence 34 is obtained, marker characters “=” and line breaks can be added to form the bCODE sequence into a transmittable message 35.

Alternative methods of redundancy coding, character/symbol representation and framing of the bCODE may be employed. As an example, just a single character, such as “a” separated by varying number of space characters, could be used to represent the encoded bits of the bCODE.

The particular form of the optically scannable code, the methods by which the codes can be scanned, the optical character recognition techniques, and the algorithms by which the codes can be converted from their coded format into relevant data are described the Applicant's earlier patent applications discussed above and are not considered to be essential to the present application. The use of bCODE terminology is by way of example only in the interests of consistency, clarity and conciseness and is not intended to be limiting. The person skilled in the art will recognize that optically scannable codes may be rendered in many forms and the present application is not to be limited to the specific bCODE format herein described. Throughout the present specification, the term bCODE should be considered in its broadest sense as a delivery token which can be delivered to a user.

The present inventors have herein recognized that an optically scannable coding system such as bCODE can facilitate new methods of banking and merchant transactions that have advantages over current methods of card based transactions and tokenized mobile phone based transactions. Particular advantages include the ability to deploy the methods across all mobile phone devices, increasing the rate of uptake while also increasing security.

In particular embodiments, bCODEs or similar optically scannable codes can be associated with processing tokens. The bCODE/processing token pair can be further associated with a PAN. The bCODE can be formatted into an SMS or similar message and delivered to a user via a mobile telephone network. A bCODE can then be received at a scanner of a merchant terminal during a transaction, converted to a processing token, and then the processing token can be used for processing a transaction within the financial network.

The bCODEs can be generated from previously created BIN range processing tokens for a token vault using the encoding and mapping techniques described above. Alternatively, the bCODE can be created first and then a one-way cryptographic hash can be performed on the bCODE using a proprietary key to create the processing token, within a token vault BIN range if required. This particular embodiment has the advantage that processing tokens cannot be used to generate bCODEs and only devices that know the proprietary key can be used in transaction processing.

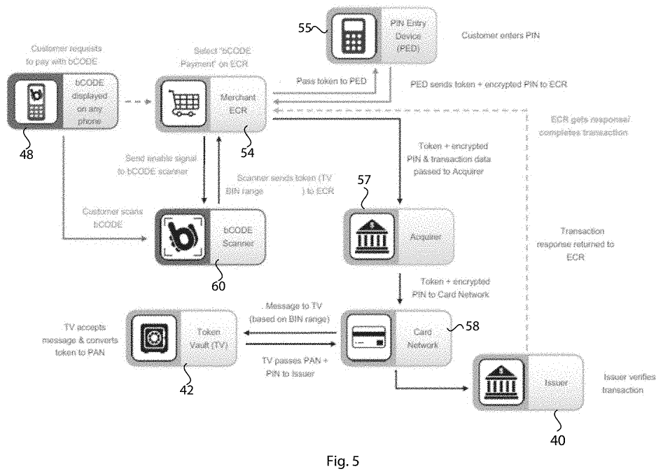

The components of such a system may include a bCODE provisioning system, an embodiment of which is depicted in FIGS. 4 and 5. Payments are supported for all mobile devices using either direct delivery (e.g. SMS, messaging service such as WhatsApp/Facebook Messenger, etc.), or delivery via an issuers wallet or a third party wallet.

This transaction may use the following optional additions to existing systems:
each issuer 40 to have access to a bCODE enabled token vault 42;
issuer's system 40 updated to add the bCODE enabled token vault 42;
issuer's system 40 updated to add bCODE delivery 44;
issuer's mobile app updated to support both requesting a bCODE for payment and delivery of the bCODE to the app;
bCODE Scanner 60 installed on the counter and connected to either ECR or POS terminal 54;
electronic Cash Register (ECR) 54 or Point of Sale (POS) terminal software updated to accept bCODE scanner input (e.g. via USB);
if POS connected, POS software modified to treat input from scanner 60 as payment token in normal transaction f low;
if ECR 54 connected, ECR software modified to treat input from scanner 60 as payment token and pass to a PIN Entry Device (FED) 56 for PIN capture. FED software modified to accept token from ECR 54 and capture PIN and process as in a normal transaction flow. This may require PCI recertification for some FED devices.

Additional work items for payments via third party applications (e.g. wallets):
wallet is updated to call the bCODE token vault 42 after capturing the users PAN via existing methods;
wallet is updated to capture response from bCODE token vault (bCODE) and push the bCODE back to the user for display.

The system requires additional elements including a bCODE token vault 42 and a bCode delivery system 44.

A bCODE enabled token vault 42 is a regular token vault modified so that two tokens are created for each PAN. The first token (the processing token) may be exactly the same as existing bank identification number (BIN) range tokens. The second token (the delivery token) is a string formatted according to the bCODE standard and is used for delivery to the mobile device. The bCode token vault 42 stores an association between the PAN, the processing token and the bCODE. The bCODE enabled token vault 42 can be run by the issuer 30 or a third party entity and made available to issuers as a new service to simplify the work required by the issuer to support bCODE.

The bCODE delivery system 44 delivers the bCODE text to the user. In one embodiment, a basic delivery system includes a simple SMS aggregator integration to send bCODE text via SMS to MSISDNs. A more sophisticated system would support sending the message to one of a number of ‘contact handles’ (e.g. twitter handle, MSISDN, email) via one of a number of channels (e.g. SMS, WhatsApp, Twitter DM, email, mobile pass format). The delivery service has many parallels with systems used today for ‘two factor authentication’ (2FA) codes and many 2FA systems are easily upgraded to support bCODE delivery. The delivery system may be run by the issuers themselves, or by a third party.

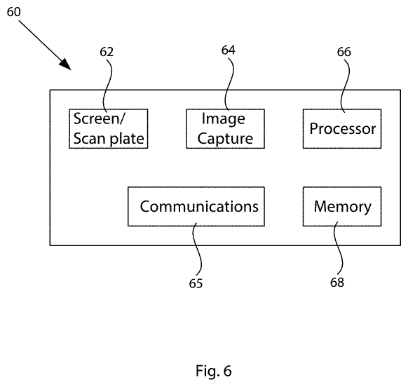

The bCODE scanner is a scanner that is configured to optically scan, i.e. image capture, delivery tokens such as bCODEs or other forms of optically scannable codes. The scanner is further configured to perform an optical character recognition process to extract from the captured image the data contained within the bCODE and to further process the bCODE to obtain a processing token. An embodiment of the scanner 60 is shown in FIG. 6.

Scanner device 60 form factor details may vary depending on the application and details of embedding of the scanner apparatus as part of existing equipment. The scanner device 60 will include a housing that contains the components of the scanner. The housing may be shaped to clip, bolt or otherwise connect to external devices such as an ECR, POS terminal, customer interface device (e.g. self-checkout machine), etc. Alternatively, the scanner 60 may be a standalone device, similar to the scanner kiosk described in the Applicant's earlier patent applications referenced above.

With reference to FIG. 6, the scanner 60 may include a screen and/or scan plate 62 and image capture component 64 (e.g. digital camera) through which an image of a phone screen displaying a bCode message may be captured. The image capture component 64 may additionally include a proximity sensor, such as an infrared sensor beam (not shown) to trigger the acquisition of an image by the digital camera 64.

The scanner 60 includes computing components including at least one processor 66 and operatively associated memory 68, for example in the form of a single board computer. The memory 68 may include memory for storing executable instructions, programs, applications, data storage etc. as well as accessible memory for use during execution of programs and instruction sets. The software stored and executed by the computing components will include OCR software for extracting text characters from the captured image, bCode software for determining the form of the bCode, and additional keys, algorithms and software for processing the bCode into at least one processing token.

The specific form of the processor and memory is subject to change with technological innovations in the computing art and thus the specific form of the computing components is not considered to be pertinent to the present embodiments.

A communications module 65 may include one or more communications ports, as well as programmed protocols for communicating information to external devices. In one embodiment, the communications module 65 may include at least one Universal Serial Bus (USB) port for connection to external devices such as an ECR or PCS terminal. USB is one form of communications though other forms of communications, by either wired or wireless protocols, will be apparent to the person skilled in the art. In other embodiments, the scanner may be configured for Local Area Network (LAN) communications, Wide Area Network (WAN) communications, internet communications, mobile network communi-cations, etc. The particular method by which the scanner 60 communicates with external devices such as the ECR or PCS terminal is not considered to be pertinent to the present embodiments.

In addition to optical scanning, the scanner 60 may include additional components for reading bCodes through non-optical means, such as via Near-Field Communications (NFC), Bluetooth, etc.

The digital camera 64, optionally triggered by a proximity detector (not shown), may be used to scan or otherwise capture an image of the mobile phone screen presented at the scan plate 64. Typically, the user will have arranged their phone to display a bCODE message so that when the image of the mobile device is captured, the message displayed on the screen including the bCODE, will also be captured.

Decoding may be performed by segmenting the bCODE from the acquired image and applying optical character recognition (OCR) to obtain a raw bCODE. Processing of the bCODE into a processing token by the processor 66 will depend on the method by which the bCODE/processing token pair was originally provisioned. In one embodiment, the scanner is programmed with keys for generating processing tokens from scanned bCODEs using the same hash algorithm employed by the bCODE API 46. Alternatively, the processor 66 may apply a reverse encoding process. In one embodiment, the reverse encoding process will be the reverse of the encoding process described above with reference to FIG. 3. That is, the reverse encoding will include a reverse character mapping and a bit-based data redundancy recovery algorithm, the result of which will reveal the original data, e.g. the BIN range token.

The framing character, e.g., “=”, of the bCode, enables well-known image processing methods to be used for segmentation. Encrypted bCODES will also require decryption to reveal the bCODE value, e.g. the BIN range token.

Prior to payment capability, the bCODE must be provisioned. This includes generating the bCODE/processing token pair, associating a user's PAN with a bCODE delivery token and BIN range processing token in the bCODE token vault and notifying the user of the bCODE for storage of the bCODE on the user's mobile device.

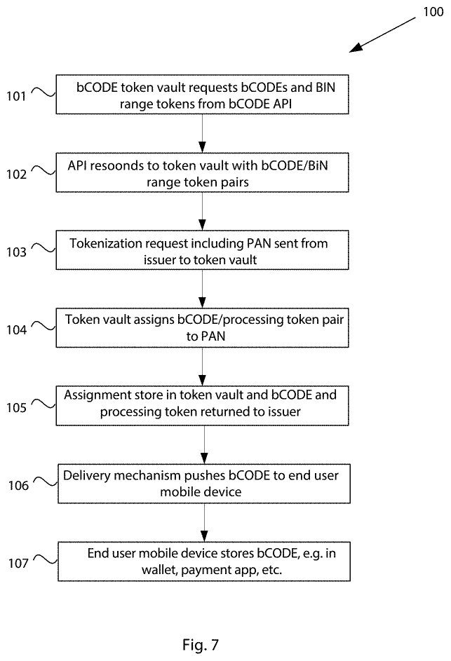

The provisioning process is illustrated in FIG. 4 and the flowchart 100 of FIG. 7. At step 101, the bCODE enabled token vault 42 makes a call 41 to the bCODE API 46. The call includes the Issuer's token vault BIN Range (e.g. 3276) and number of tokens required (e.g. 500,000 bCODEs).

The request for bCODEs can happen in bulk and ahead of time, so that the token vault always has tokens and bCODEs available for PAN assignment requests. In one embodiment, the bCODE API 46 creates bCODE values that can be assembled into delivery token messages for delivery to users. For each bCODE value, the API 46 performs a cryptographic one way hash to generate an associated processing token value for the bCODE within the token vault BIN range.

The bCODE API responds 43 (step 102) with bCODE/processing token pairs, e.g.:
PAN like Token in TV BIN Range (e.g. 3276 12345678 9101)
Matching bCODE, e.g.:
   =AB ODE =AB C DE=
   =12345=XYZAB=
   =LMPR1=XXXXX=

A step 103, a token request 45 is triggered by the Issuer 40 according to their own business rules. For example, a customer could request a mobile payment by making a selection in the Issuer's mobile banking app, or tokens could be pushed out to existing Issuer customers. For third party wallets, the token request is triggered when the PAN (e.g. credit card number) is entered by the end user. The Issuer request 45 to the bCODE enabled token vault 42 includes the PAN and a request for a processing token. Token vaults may be different for different PANs—e.g. Visa PAN (4511 1234 5678 9023) may be required to go to Visa token vault. If a particular PAN, e.g. VISA PAN, is required to be tokenized using a prescribed or mandated token vault (e.g. VISA token vault) that does not support bCODE, then the PAN is passed to the prescribed token vault first (e.g. VISA token vault), and then the token from that prescribed vault, e.g. a VISA token, is passed to the bCODE enabled token vault 42 as the PAN. The processing token thus stored in the bCODE token vault may be considered as a pointer to the actual processing token stored in the prescribed token vault.

In response to receiving the PAN tokenization request 45, the bCODE token vault 42 selects one of the previously provisioned bCODE/token pairs and assigns it to the PAN (step 104). The association of the PAN with the bCODE and processing token are stored in the token vault 42 and a bCODE is returned 47 to the Issuer along with the normal processing token (step 105). The Issuer stores the bCODE as they would the normal token.

The Issuer then invokes a bCODE delivery mechanism by sending the bCODE, contact handle and method of communication to a bCODE delivery service 44. e.g.
=AB C DE =AB C DE=
=12345=XYZAB=
=LMPR1=XXXXX=
@twitterhandle Twitter DM

The delivery service transmits the bCODE to the end user (step 106) by the specified delivery method. At step 107, the received bCODE is received into the user/customer's mobile device 48 where it can be stored as appropriate. In the case of a mobile app (Issuer app or third party wallet), the bCODE is delivered directly to the app via push notification as an alternative method of delivery.

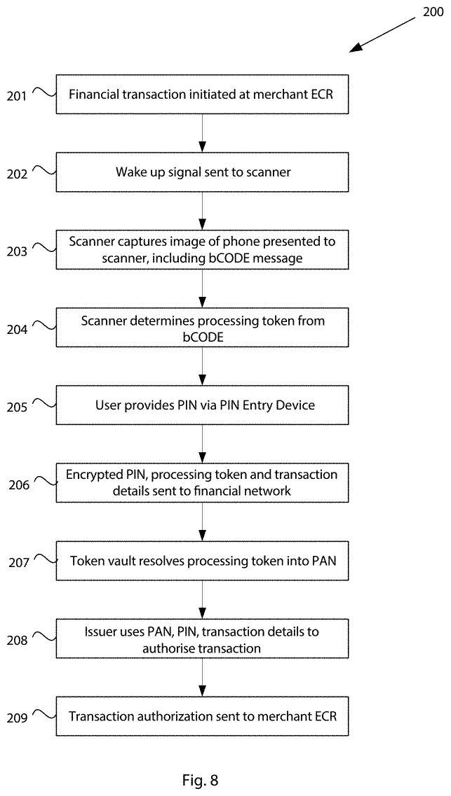

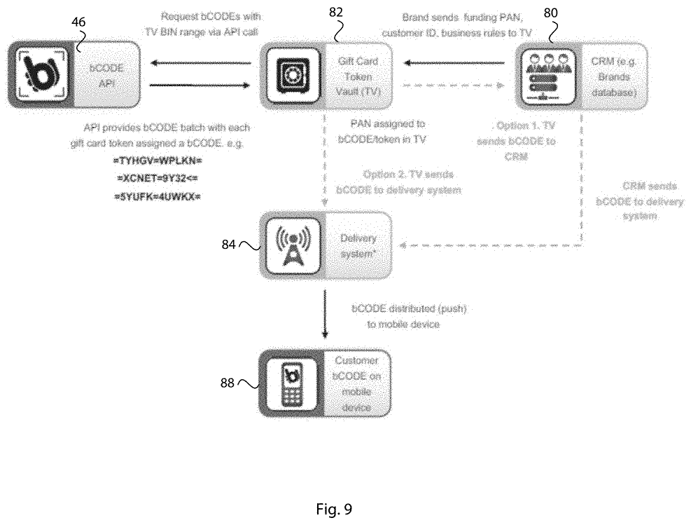

Once the bCODE has been provisioned in the token vault and supplied to the user device 48, the user may then use the bCODE in financial transactions. A financial transaction method is depicted in FIG. 5 and the flowchart 200 of FIG. 8.

A user initiates a mobile device transaction at a point of sale that is configured with a bCODE scanner 60 (step 201). The merchant's ECR 54 sends an ‘enable’ signal to the bCODE scanner 60 to wake it up (step 202). The scanner shows a red scan illumination to indicate to customer where to scan. The bCODE device 60 connects to ECR 54 via USB, using USB HID keyboard or JPOS protocols. Other wired or wireless connections and communications protocols therefore will be apparent to the person skilled in the art. At step 203, the scanner 60 scans the bCODE from the user device 48.

The scanner 60, being programmed with appropriate bCODE processing algorithms, such as the same cryptographic one way hash used by the API 46 in the original provisioning process, converts the bCODE into a BIN range token (processing token) (step 204) and sends the processing token to the ECR 54.

For example, a bCODE token:
=AB ODE =AB C DE=
=12345=XYZAB=
=LMPR1=XXXXX=
   may be converted to:
3276 1234 5678 9101.

The ECR 54 then passes the BIN range token to a PIN Entry Device (PED) 55 coupled to the ECR and the customer enters the PIN on the PED 55 (step 205).

The PED 55 sends the processing token and encrypted PIN to the ECR (e.g. using industry standard PIN Block formats).

At this point in the transaction flow, the ECR 54 has received a conventional token based transaction request including transaction value, payment token and encrypted PIN. All the subsequent steps require no modification from existing token based financial processes but are described here for clarity. A person skilled in the art will readily understand that some or all of these steps may be modified or omitted as required, depending on the particular transaction and parties involved.

At step 206, the PCS passes the processing token, encrypted PIN and transaction details into the financial network, starting with an Acquirer 57. The Acquirer 57 passes the processing token, encrypted PIN and transaction details to the Card Network 58 which passes the token, encrypted PIN and transaction details to the token vault 42, routing the token to the appropriate token vault based on the token BIN range.

The token vault 42 looks up the processing token and converts the processing token to the associated PAN (step 207), which is sent back to the network 58 (with encrypted PIN, token vault and transaction details).

In the case that the processing token was generated from a brand mandated token and thus the token stored in the bCODE token vault is a pointer to the prescribed token vault, this step will convert the bCODE processing token into the card brand token, rather than the actual PAN. However, when the network sees this message it will simply see the card brand token and pass that to the card brand token vault which will convert the token to the final PAN and back to the network.

The Network 58 passes the final PAN, encrypted PIN and transaction details to Issuer 40 who validates the transaction (step 208) and returns the response to network 58.

The Network 58 forwards the transaction response returned to ECR 54 which completes the transaction (step 209).

In addition to payment processing, the presently described transaction system can be used to perform Customer Relationship Management (CRM) aspects of a transaction, including gift cards and loyalty program handling.

This transaction may require the following additions to the existing systems that support bCODE payments:
bCODE support is added to the existing system that the gift card provider uses to generate BIN range values for gift cards. This is the same as adding a bCODEs field to a payment token vault to create bCODE/gift card token pairs as described previously.
gift card provider adds support to store the bCODE (if this is a separate system to the previous one).
bCODE delivery can be managed either by the originating brand CRM or the gift card provider. If managed by the gift card provider, then the gift card provider must integrate with a bCODE delivery service and the brand CRM has to provide the gift card provider with contact handle and method of delivery. If the brand CRM is managing delivery, this improves customer data security, since it is no longer necessary to provide the gift card provider with any contact details for the end customer. In this case, the brand CRM may integrate with a bCODE delivery system and pass the bCODE provided by the gift card provider to the delivery system.

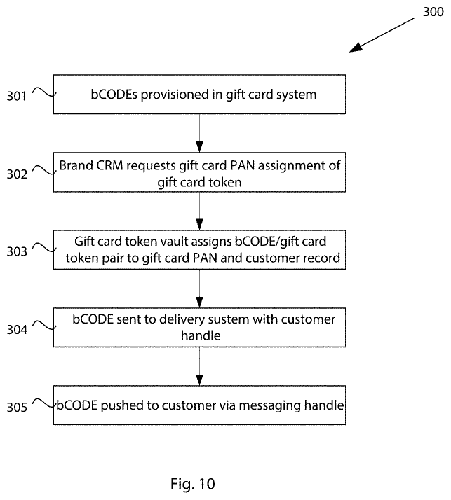

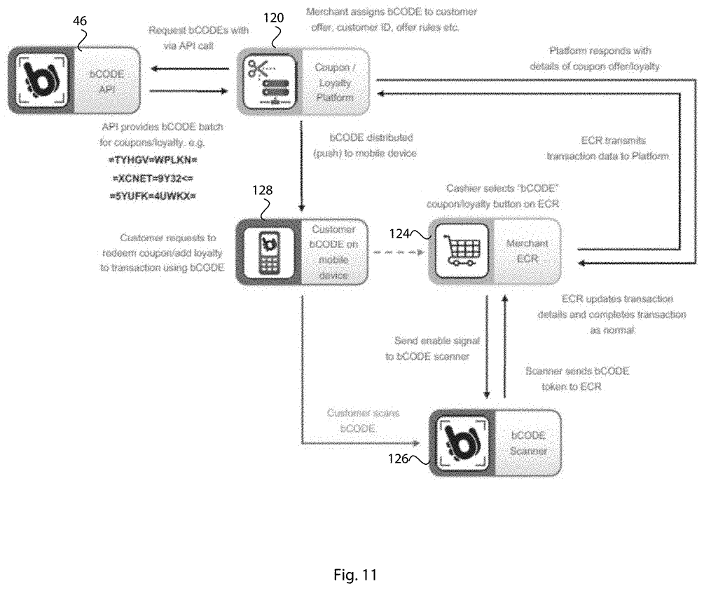

FIG. 9 and the flowchart 300 of FIG. 10 show a process by which BIN range based (open loop) gift cards and rewards can be transacted using bCODE. BIN range based gift cards are requested by a brand CRM (or similar system).

At step 301, bCODEs are provisioned into the gift card provider's system 80 in a manner similar to that for bCODE payments described previously. That is, bCODE and gift card token pairs may be provisioned in a gift card token vault 82 by first making a call to a bCODE API 46 for a specified number of bCODE/token pairs within a gift card token vault BIN range.

When a gift card is required, the brand CRM 80 sends a request to the gift card provider with customer identifier (step 302). This request includes details such as the real PAN that is financing the cards (or a surrogate thereof), and any rules about what is allowed (e.g. only purchases under $100, or only a total of $50 of purchases per customer before August 31).

The gift card provider requests a bCODE and Token pair from the gift card token vault 82 with the customer identifier. The gift card token vault 82 understands the payment rules for the gift card and knows what the real PAN is and under what conditions to forward the transaction request to the original PAN issuer for approval/transaction completion. The gift card token vault 82 assigns the bCODE/token pair to the PAN and customer record (step 303).

The bCODE gift card delivery (step 304) is much simpler and more scalable than traditional gift card delivery which opens new approaches to distribution.

In a first approach, the customer contact details are passed to the gift card provider and the gift card provider manages the delivery of the bCODE to the end customer.

The second approach, is that the gift card provider simply passes back a bCODE to the brand CRM, and then the brand CRM system integrates with a bCODE delivery service to deliver the bCODE. The benefit of this approach is improved end customer data security since contact information is not shared with the gift card provider.

A further option is for the gift card token vault, which is provided with the customer details, can provide the bCODE and customer handle to the delivery system.

The delivery system 84 pushes the bCODE to the mobile device 88 (step 305) via SMS, in app messaging, or by other methods similar to the payment methods described above.

bCODEs, once properly provisioned, can be used in merchant closed loop transactions. Merchant based closed loop coupons and loyalty fall into two types:
1. Merchants with modern ECR systems that are integrated with a CRM system and can understand loyalty and coupon identifiers, and
2. Merchants with ECR systems that are not integrated with a CRM system.

### Merchants with an ECR Integrated into Their CRM

For these merchants, the ECR already knows how to scan and process a loyalty card, and sends that information off to a CRM/Loyalty platform that knows what to do with it. This platform may be a third party. It may simply accumulate points in a third party platform or there may be responses defined and understood by the ECR. i.e. Loyalty/CRM platform passes response back to ECR that says this customer should have 10% deducted from bill.

Support for bCODE closed loop coupons and loyalty requires the following additional integration tasks:
coupon/loyalty platform integrates with bCODE API for provisioning of bCODEs;
coupon/loyalty platform is updated to allow coupons to be accessed by their bCODE token identifier;
coupon/loyalty platform integrates with a bCODE delivery system for delivery of bCODEs;
the bCODE scanner is integrated directly with the ECR in the same way as for payments.

ECR adds support for an additional operator button that enables the scanner when customer wants to scan a coupon or loyalty code and captures the bCODE token from the scanner and passes it back to the coupon/loyalty platform in the same way that they pass the existing loyalty card identifiers.

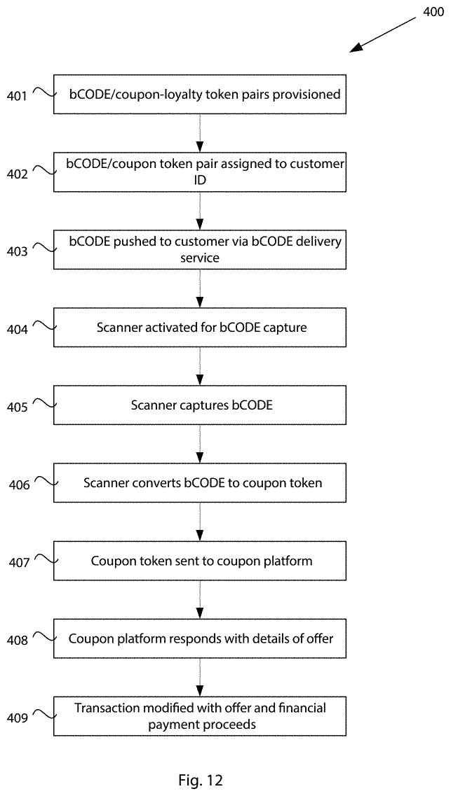

A process for handling closed loop coupons and loyalty, including prior provisioning, with ECR integrated CRM is shown in FIG. 11 and the flowchart 400 of FIG. 12.

At step 401, the Coupon/Loyalty platform 120 requests bCODEs and tokens, in bulk and in advance as for payments, via a call to the bCODE API 46. It should be noted that for coupon and loyalty programs, the tokens do not have to be BIN range format. A bCODE and token may be stored in coupon/loyalty system 120 and linked to a particular customer (step 402) and the bCODE may be sent to the end user using a bCODE delivery service (step 403).

At some later transaction, the user indicates that they have a coupon/loyalty bCODE and the operator selects ‘bCODE Coupon/Loyalty’ button on ECR 124. For each third party coupon loyalty system that the merchant wants to support, an additional button may be added to the ECR 124. The operator may ask user what type of loyalty coupon it is and press the corresponding button. In response the ECR 124 activates the bCODE scanner 126 to accept a scan (step 404).

The user scans the bCODE 405 from their mobile device 128 and the scanner 126 converts the bCODE to a bCODE processing token and sends the bCODE processing token to the ECR 124 (step 406). The ECR 124 captures processing token and sends it to the coupon/loyalty system 407. The processing token is sent in the same way that existing loyalty card numbers are sent to the coupon/loyalty system. The coupon/loyalty platform 120 responds to the ECR 124 with details of the offer (e.g. reduce transaction total by 10%) 408 and the ECR 124 updates the transaction details and total accordingly and then proceeds with the transaction as normal 409, e.g. by then completing the financial payment aspects of the transaction.

### Merchants with ECR Systems Not Integrated with a CRM

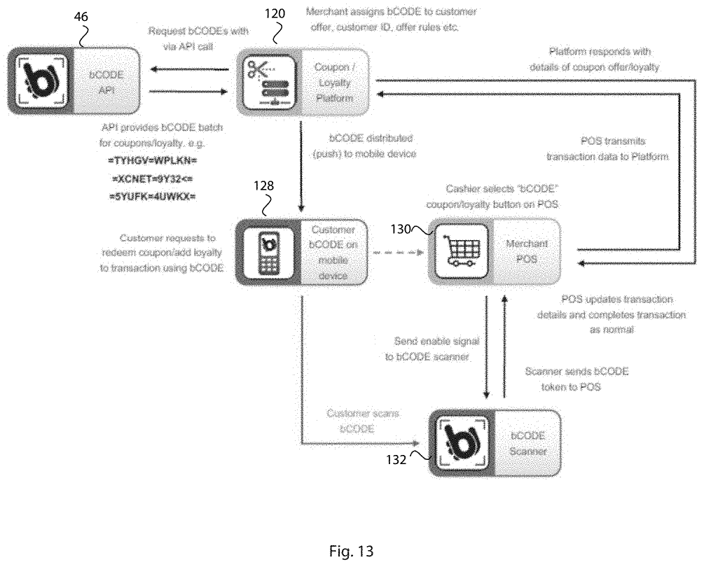

Merchants who do not have the ECR integrated directly with the CRM are still able to take advantage of coupon and loyalty features of independent CRM systems by integrating the bCODE scanner 132 (FIG. 13) directly with the credit card terminal (POS) 130. Coupons and loyalty offers through this method are more limited than when the ECR is directly integrated into the CRM. In particular, the CRM is not able to take advantage of specific details of the basket in the offer. For example, offering 50% off the purchase price of one brand of shampoo is not possible. Offering 5% reduction in the total transaction amount is possible.

Support for this method of bCODE closed loop coupons and loyalty requires the following additional integration tasks:
coupon/loyalty platform integrates with bCODE API for provisioning of bCODEs;
coupon/loyalty platform is updated to allow coupons to be accessed by their bCODE token identifier;
coupon/loyalty platform integrates with a bCODE delivery system for delivery of bCODEs;
the bCODE scanner is integrated directly with the POS in the same way as for payments;
POS adds support for an additional operator button that enables the scanner when customer wants to scan a coupon or loyalty code and captures the bCODE token from the scanner and passes it back to the coupon/loyalty platform.

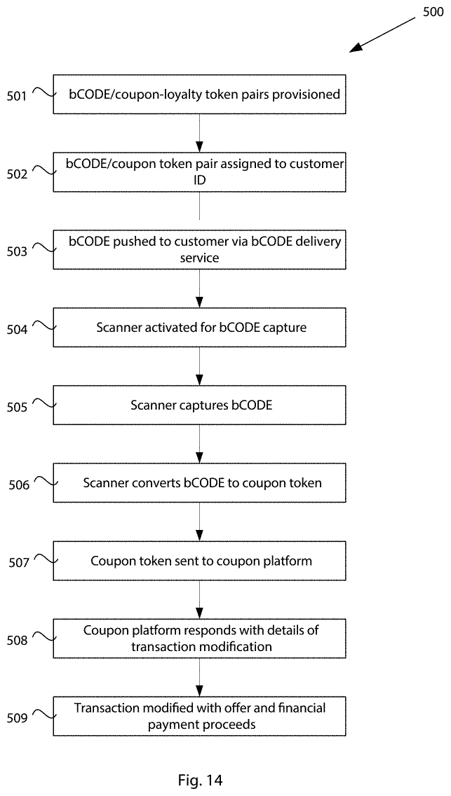

A process for handling closed loop coupons and loyalty, including prior provisioning, with bCODE scanner integrated into the POS terminal is shown in FIG. 13 and the flowchart 500 of FIG. 14.

Coupon/Loyalty platform requests bCODEs and tokens in bulk, in advance as previously described (step 501). Tokens do not have to be BIN range format. Pre-provisioned bCODE/token pairs can then be associated with end user's during a registration process (step 502), with the user details being stored in the token vault. The bCODE is sent to end user using bCODE delivery service (step 503).

During a transaction, the user indicates that they have a coupon/loyalty bCODE and the operator selects ‘bCODE Coupon/Loyalty’ button on POS terminal 130 which is modified to support input of a loyalty identifier. Multiple loyalty system support may require multiple buttons or a hierarchical menu to filter down to a particular loyalty system. The POS activates the bCODE scanner 132 to accept a scan (step 504) and the user scans the bCODE (step 505) from their device 128. The scanner converts the bCODE to a bCODE processing token and sends it to the POS 130 (step 506). The POS 130 captures the token and sends it to the CRM/loyalty system 120 for processing into a customer record and action response (step 507). The CRM loyalty/platform responds to the terminal with instructions on how to modify the transaction (step 508). An example response may be to reduce a transaction total by 10%. Options may be less for terminal based system since only a transaction total can be modified, rather than item specific actions.

At step 509, the terminal updates the transaction total and then proceeds with the transaction as normal.

### Variations and Modifications

While the present embodiments and examples describe that the scanner obtains the bCODEs through optical image capture and OCR resolution, the scanner is further described as having capability for receiving the bCODE from a mobile device via other techniques, including near-field communication data transfer using various protocols. For many of the embodiments and examples, the manner by which the scanner receives the bCODE from the mobile device is not essential and the person skilled in the art will recognize that the embodiments herein described are intended to capture within their scope other such data transfer methods.

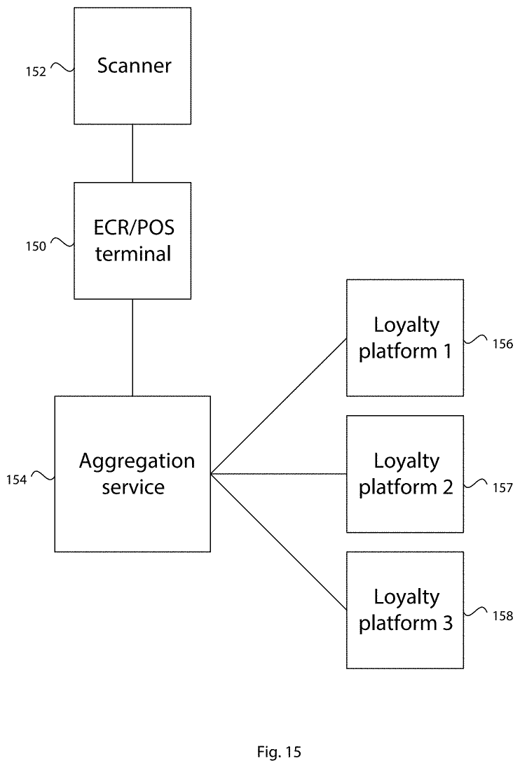

The use of a bCODE system as herein described can assist merchants in managing multiple third party coupon and loyalty programs. In order to avoid the integration and usability issues of the cashier having to press separate buttons for separate loyalty/coupon programs, an aggregation service can be provided. The bCODE system can already know what tokens belong to which loyalty platform via the API call of the provisioning process described above. So rather than ask the user and press a button before routing the loyalty/coupon token to the right platform, all tokens can be routed first to a central bCODE system 154 (FIG. 15) that handles loyalty transactions for multiple loyalty platforms 156, 157, 158. The aggregation service 154 determines which platform or token vault the token belongs to and forwards it on.

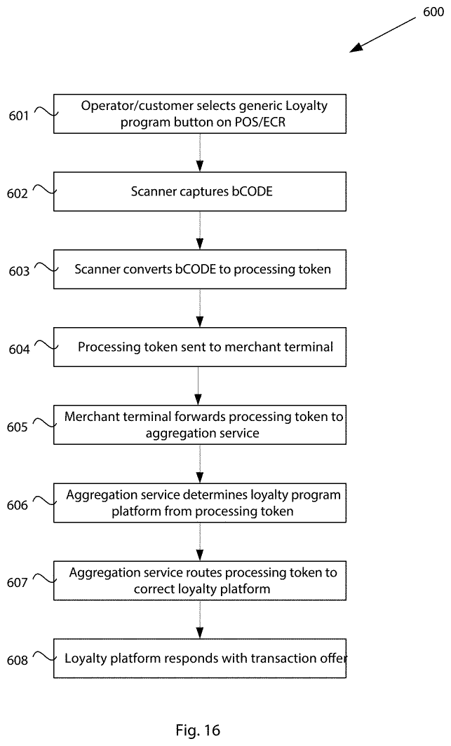

An embodiment of this process is shown in FIG. 15 and the flowchart 600 of FIG. 16. At step 601, the operator (which may be the user for self-checkout transactions) at the merchant terminal 150 either the ECR or PCS terminal, selects a generic loyalty program button that relates to multiple loyalty programs 156, 157, 158 handled by the aggregation service 154. The bCODE scanner 152 then captures a bCODE from a device (step 602). The bCODE scanner 152 coverts the bCODE to a processing token (step 603) and sends it to the terminal 150 (step 604). The terminal 150 routes the token to a central bCODE token server (aggregation service) 154 (step 605) which processes the token to determine the token vault/platform in which the token is provisioned (step 606). The central server 154 forwards the token to the platform (step 607) where processing continues as described previously which responds with a transaction offer (step 608).

bCODEs issued as payment tokens represent valid BIN range tokens. Further, bCODEs, being optically readable alphanumeric character strings, can be read by the user and entered into online forms in a manner similar to credit card numbers from physical credit cards, but with added security. This allows them to be used for online payments as well as offline payments.

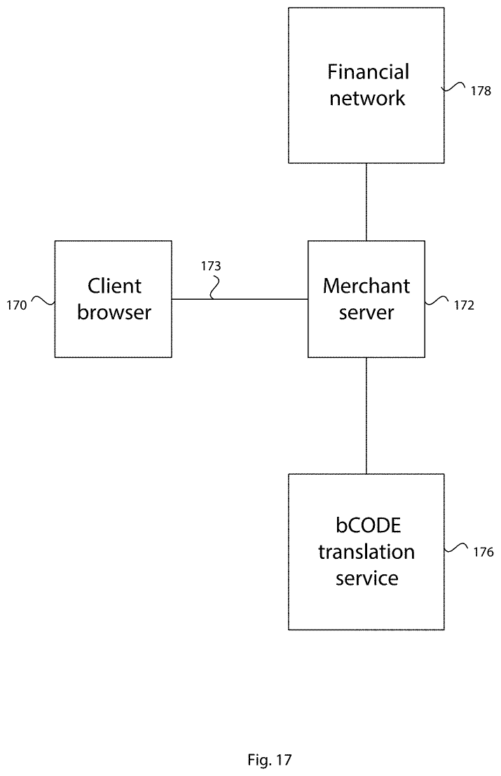

A web based merchant system is depicted in FIG. 17. In this system, a user at a client browser 170 can view an online shopping page presented by a merchant server 172 via a network connection such as the Internet 173. The client browser may be on the user's mobile device, or another computer terminal. For online payments it is necessary to have a means to convert the bCODE text available on the user's mobile device into the bCODE BIN range token at the merchant side. This can be done by:
asking the user to enter the bCODE text into one or more fields of a webpage form, and then, having the merchant web site pass the bCODE text to a bCODE translation service 176 to convert that into the bCODE BIN range token and then executing the transaction.
asking the user to capture the bCODE text using their web cam and then passing that image via the merchant server to the bCODE translation service 176 to convert that image into the bCODE BIN range token.

In an alternative embodiment, the OCR processing of the image can occur in browser, or in the merchant server 172 so that the only information that is passed to the interpretation service 176 is the bCODE text.

In either case, the translation service 176 provides the interpretation function that was performed within the scanner in the previous embodiments in which the bCODE text was decoded into the associated processing token. Once the merchant server has the bCODE processing token associated with the bCODE, the merchant server 172 can forward the processing token into the financial network 178 for payment processing as previously described.

It will be apparent to the person skilled the art that the online shopping system of FIG. 17 could equally handle gift card, coupon and loyalty programs in a similar to that described previously. In such embodiments, the user would provide a bCODE, e.g. gift card bCODE at the client browser which would be forwarded to the bCODE translation service 176 for translation into the relevant processing token.

Because bCODEs can be delivered by any data and non data dependent delivery systems (SMS, USSD, app push/pull, social media messaging platforms), it is handset and carrier agnostic, with the scanning technology able to work in an offline environment. Thus, bCODEs systems can be readily created and deployed, allowing issuing banks and merchants to circumvent third party token service providers and the associated fees.

bCODEs are read by either:
a proprietary scanning device that is connected and powered by any USB-enabled hardware which includes credit card terminals, retail Point of Sale (POS) systems, tablets or a smartphone, or,
an application scanning library that enables phone to phone scanning (e.g. add bCODE to Uber, or scan from merchant app).

Both forms of bCODE scanning technology use advanced optical algorithms that provide high-reliability, high-speed scanning from the screens of all mobile devices.

As a token based system, bCODE solutions bring all the security improvements of tokenization over traditional authentication methods to 100% of mobile devices. It is compatible with virtually all delivery systems and provides a method to tokenize primary account numbers (PANs) or PAN tokens that stores no data on a mobile device but allows issuers to map consumer data to a transaction. This may be used for payments, loyalty, coupons, instant offers and tickets and distributed to 100% of mobile devices without needing additional chips, apps or data connectivity, whilst increasing the level of security.

bCODE provides a common identifying mechanism that is available across all countertops and devices. This enables all service providers to be able to transact in the way that they wish while not being locked into specific devices. Issuers can also reduce or eliminate the hassle and high costs associated with issuing and managing physical cards, instead providing them with an identifier. This identifier is able to transact on any device, regardless of make, age, or capability

The tokenization of PAN numbers and PAN tokens via bCODE adds a layer of security that current chip technologies cannot provide.

There is no personal data stored in a bCODE. Its integration with a token vault (TV) provides a significant additional layer of security and mitigates this risk for adopters of the technology.

It is a feature of the present embodiments that the token that the customer has on their phone, i.e. the bCODE, and the token that is used to process the payment are different. This allows the lifecycle of one to be managed separate to the other.

### EXEMPLARY USAGE CASE EMBODIMENTS

### Example 1

### User Profile: Smartphone Mobile Apps

Bob is a 25-year old male with a smartphone and a mobile data plan. His phone is constantly online and he prefers to use vendor specific mobile apps for banking, loyalty and tickets due to the enhanced functionality and more personalized user experience.

### Mobile Payment

Bob has downloaded his financial institutions mobile banking app to his phone, completing the registration and signs in to the app. The bank pushes a bCODE payment identifier into the app. When he visits his favorite brand store, he opens the app and selects the bCODE identifier for the account from which he wished to transact. The bCODE string is displayed on the phone's screen and he scans the bCODE on the merchant's reader for payment.

### Combined Payment, Loyalty, Rewards and Coupons

The account is also enrolled in the financial institution's Rewards program which includes a cross-merchant loyalty program. Simultaneous with the payment, points are credited to his Rewards scheme. After spending over $1,000 on his account. Bob achieves a rewards bonus. He receives an in-app push loyalty message with a bCODE string for $10.00 reward value at a national pharmacy chain. He heads to the store where he opens the in-app message and scans the bCODE on the bCODE Scanner to redeem the $10.00 reward value for payment. Once redeemed, the rewards value is deducted from the stored value and removed from the app.

### Loyalty

Bob has downloaded the mobile store app for his local supermarket. He has registered for the loyalty scheme and is issued a bCODE which is stored in the app. After his tenth purchase, scanning his loyalty bCODE with each purchase, he receives a bCODE with coupon offers which he redeems on his next purchase.

### Example 2

### User Profile: Mobile Wallet/Passbook

Susan is a 30-year old female with a smartphone, but with a limited mobile data plan and Susan does not want to use various mobile apps on a day-to-day basis. Susan is budget conscious and prefers to use free Wi-Fi networks when out and about, especially when travelling internationally where data roaming costs can be high. She prefers to keep her payment, loyalty, tickets and coupons in her smartphone's Passes app, so that she has access to the passes when offline. She adds passes containing bCODEs issued from her bank and other service providers via email, messages and Passes enabled apps.

### Mobile Payment

Susan is signed up to her local financial institution's mobile banking service. She is sent an account identifying bCODE to her phone, with the bank pushing a bCODE payment identifier via her banking app, where she adds the bCODE to her Passes app. When she visits her local grocery store, she opens the Passes app, and selects the bank account bCODE. The bCODE string is displayed on her phone and she scans the bCODE on the reader for payment.

### Coupons

Susan is browsing her favorite fashion blog. She reads an online article which has a promotional offer for 20% off any T-Shirt at a national apparel chain. The article is embedded with a Pass-enabled button to add the coupon to her phone's Pass app. In store, she opens the coupon in her Pass app and scans the bCODE on the reader to redeem the 20% off coupon.

### Loyalty

Using her email address, Susan has registered for a national pharmacy store loyalty scheme through the company's website. She receives an email confirming her registration. The email contains a bCODE string and a Pass-enabled button so she can add the digital department store loyalty bCODE to her phone's Pass app. Each time she shops at the store, she opens her Pass app to scan the bCODE at checkout. After 6 visits, she receives an email with a bCODE string for 20% off which she adds to her Pass app and redeems on her next trip to the store.

### Example 3

### User Profile: Text & Image Delivery Systems Only

James is a 40-year old male with a “feature” phone and no mobile data plan. He lives in a remote area with limited infrastructure for connecting to the internet. He uses his mobile phone for phone calls and SMS.

### Mobile Payment and Coupons

James is signed up to his local financial institution's mobile banking service. The bank pushes a bCODE payment identifier to the phone via SMS. When he visits his local grocery store, he opens the SMS bCODE. The bCODE string is displayed on the phone's screen and he scans the bCODE on the reader for payment. Optionally, he may receive an SMS confirming the remaining balance on his bank account, along with an instant SMS offer of a free soda on his phone for redemption in store.

### Loyalty

James has registered his mobile phone number for a nationwide gas station loyalty scheme. He receives a bCODE string by SMS for the loyalty scheme. After his fourth visit in a one month period, scanning his loyalty bCODE on each visit, he receives an SMS with a bCODE string for a free car wash ticket which he redeems on his next trip to the station.

### Other Variations and Modifications

It can be seen from the above examples that a particular advantage of the presently described system is that the bCODEs are able to function across all devices and handle both payment and loyalty transactions without the user ever needing to be issued with a physical card.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

1. A method of provisioning a system for using processing tokens for transactions, the method including:
generating an optically scannable code;
generating a processing token from the optically scannable code via a one-way cryptographic hash algorithm;
associating the processing token with an account identifier of a user;
storing the association between the processing token and the account identifier in a token vault;
generating an optically scannable message including the optically scannable code; and,
delivering the optically scannable message to a device of a user.

2. The method of claim 1, including delivering the processing token to an issuer of the account.

3. The method of claim 1, wherein the processing token has the form of a Bank Identification Number (BIN) range processing token.

4. The method of claim 3, wherein the processing token is a pointer to a second processing token stored at a second token vault.

5. The method of claim 1, wherein the account identifier either:
is a Primary Account Number (PAN) of a financial institution and has the form of a BIN range account number; or, represents a loyalty account of the user with a loyalty account issuer.

6. (canceled)

7. The method of claim 1, including storing an association between the optically scannable code and the processing token at the token vault.

8. The method of claim 1, wherein the device of the user includes a mobile telephone device, a smart phone, a smart watch or any other user device including a mobile device of a user.

9. A method for conducting a financial transaction using a user device and a merchant terminal, the method including:
a. receiving an optically scannable code from a user device at a scanner device associated with the merchant terminal;
b. the scanner converting the optically scannable code into a Bank Identification Number (BIN) range processing token via a one-way cryptographic hash algorithm; and
c. providing the BIN range processing token from the merchant terminal into a financial network for authorizing payment for the transaction to the merchant from a Primary Account Number (PAN) associated with the BIN range processing token.

10. The method of claim 9, wherein the financial network provides the BIN range processing token to a token vault that stores an association between the BIN range processing token and the PAN.

11. The method of claim 10, wherein the token vault receives the BIN range processing token and returns the PAN associated with the BIN range processing token to the financial network for subsequent transaction authorization.

12. The method of claim 10, wherein the token vault receives the BIN range processing token and returns a second BIN range processing token of a second token vault, wherein the financial network provides the second BIN range processing token to the second token vault to retrieve the PAN for subsequent transaction authorization.

13. The method of claim 9 wherein the token vault further stores an association between the BIN range processing token and the optically scannable code.

14. The method of claim 9 wherein obtaining the optically scannable code includes obtaining an image of a screen of the mobile device while the screen is displaying the optically scannable code.

15. The method of claim 9 including:
generating the optically scannable code;
generating the processing token from the optically scannable code via the one-way cryptographic hash algorithm;
associating the processing token with the PAN;
storing the association between the processing token and the PAN in the token vault;
generating an optically scannable message including the optically scannable code; and,
delivering the optically scannable message to the user device.

16. The method of claim 9, wherein the user device includes a mobile telephone device, a smart phone, a smart watch or any other user device including a mobile device of a user.

17. A system for providing transactions using tokenization processes, the system including:
at least one token vault;
at least one Issuer that stores a primary account number for at least one user; and,
at least one token provisioning module configured to:
generate at least one optically scannable code;
generate at least one processing token from the optically scannable code via a one-way cryptographic hash algorithm;
wherein the at least one token vault is configured to store an association between an optically scannable code/processing token pair and a primary account number.

18. The system of claim 17, wherein the at least one Issuer either:
a financial enterprise, wherein the primary account number represents a financial account and wherein the processing token is configured to be used in a financial transaction authorization process: or, operates a loyalty program, wherein the primary account number represents a loyalty program account and wherein the processing token is configured to be used in a loyalty program transaction.

19. (canceled)

20. The system of claims 17, including at least one merchant terminal including at least one scanner device, the merchant terminal configured to:
obtain the optically scannable message from a user device;
process the optically scannable message to obtain the at least one optically scannable code;
process the obtained at least one optically scannable code via the one-way cryptographic hash algorithm to obtain the at least one processing token; and,
provide the processing token to a transaction processing network.

21. The system of claims 17, including a delivery mechanism programmed to:
generate the optically scannable message including the optically scannable code; and
deliver the optically scannable message to a user device.

22. (canceled)

23. The system of claim 17, wherein the optically scannable code is in the form of a character sequence.
